(19) United States
(12) Patent Application Publication
(10) Pub. No.: US 2023/0064718 A1
(43) Pub. Date: Mar. 2, 2023

(54) AUTOMATED SELECTION OF CONFIGURATION DATA

(71) Applicant: X Development LLC, Mountain View, CA (US)

(72) Inventors: Julia Black Ling, Redwood city, CA (US); Kira Kamilla Smiley, E. Palo Alto, CA (US); Jung Ook Hong, Sunnyvale, CA (US); Christopher Leslie, San Francisco, CA (US)

(21) Appl. No.: 17/465,368

(22) Filed: Sep. 2, 2021

(51) Int. Cl. G06N 20/00; A23K 50/80; G06K 9/62; A01K 61/80

(52) U.S. Cl. CPC G06N 20/00; A01K 61/80; A23K 50/80; G06K 9/6256; G06K 9/6262

(57) ABSTRACT

Methods, systems, and apparatus, including computer programs encoded on a computer storage medium, that automate selection of configuration data. One of the methods includes obtaining meal configuration data relating to feeding livestock in an aquaculture environment that includes one or more feeding parameters relating to feeding farmed livestock and one or more criteria. Each of the one or more criteria can be associated with the one or more feeding parameters. Sensor data can be obtained that describes at least one property of the aquaculture environment. A selected set of feeding parameters can be selected using the obtained sensor data and the obtained feeding parameters. The selected set of feeding parameters can be provided to a feeding control subsystem.

### FIELD

This specification generally describes enhanced feeding systems for fish in aquaculture environments.

### BACKGROUND

Researchers and fish farm operators face several challenges when feeding fish. Providing more food than what is required for normal growth can result in food waste as well as a corresponding increase in food expenses. Alternatively, providing less food than what is required for normal growth can affect the health of farmed fish, and can reduce the quality and yield of the final product.

A manual process of observing and adjusting feed provided to fish is often used to monitor feeding levels, but this approach requires workers to be on site to monitor and control fish pen activity. Such a manual process is often time-consuming, expensive, and has several limitations, such as when cameras used to monitor fish activity are not correctly positioned or when operational logistics decrease the availability of human observers.

### SUMMARY

In general, this specification describes both an approach for feeding livestock, such as fish within an aquaculture environment using a meal plan, as well as a framework for selecting among alternative meal configuration data in response to sensor data, and making improvements to meal configuration data using techniques such as reinforcement learning or active learning.

More particularly, innovative aspects of the subject matter described in this specification relate to the monitoring and imaging of fish and fish feed, for example in the context of aquaculture. A “feeding session” can describe how fish are to be fed at a given time and for a given duration, such as during the “main meal” or perhaps during a “validation meal.” The parameters to be used during a feeding session are contained in “meal configuration data,” or simply “configuration data,” for convenience. Examples of configuration data can include parameters such as the intensity at which to feed, a rate to increment the intensity of feeding, the percentage feed rate reduction when fish appetite wanes, etc. Each parameter of the configuration data can have an associated value, such as 150 grams per second for a feeding intensity.

In one example implementation, feeding sessions are defined by meal configuration data which specifies at least one value that is determined based on a sensed feeding condition. For example, a feeding rate, which is managed by a feeding application programming interface (API) that controls a feeding system that disperses food using a tube and feed spreader, can be determined based on the depth that feed pellets are seen to be falling within the pen by a camera.

According to another example implementation of the subject matter, configuration data of a meal plan is used to control a feeding device for fish. Images of the fish obtained by a camera during feeding are analyzed to determine subsequent actions based on the configuration data. Researchers or fish farm operators can adjust parameters of the configuration data to adjust the feeding of fish. The parameter adjustments can be used to determine optimal feeding, including maximizing growth while minimizing food waste.

Advantageous implementations can include a submersible camera device that obtains images and video of fish and the surrounding environment. The submersible camera device can patrol a pen containing fish and capture images and video that can be processed by onboard computers or can be sent to a remote computer for processing. The submersible camera can capture images and footage that can be used to determine, among other things, if fish are still feeding or if feed is falling below a threshold indicating that fish are likely done feeding for a period of time.

Researchers or fish farm operators can adjust parameters of the configuration data iteratively to optimize the feeding process. By automating the feeding, unintentional changes to a specified meal plan caused by manual processes can be reduced. In this way, feeding can be more correlated with specific, configurable parameters of the configuration data enabling more accurate A/B testing as well as optimization. In addition, one or more machine learning models can be used to determine adjustments for feeding parameters using sensor data that measures the effectiveness of feeding parameters, further improving the feeding process.

One innovative aspect of the subject matter described in this specification is embodied in a method that includes obtaining meal configuration data including one or more parameters indicating a meal plan for feeding farmed fish; executing the meal plan based on the meal configuration data; receiving sensor data from one or more sensors during execution of the meal plan; and adjusting the execution of the meal plan based on the sensor data from the one or more sensors. In addition, parameter of the meal plan can also be adjusted.

Another innovative aspect features obtaining meal configuration data relating to feeding livestock in an aquaculture environment that includes one or more feeding parameters relating to feeding farmed livestock and one or more criteria. Each of the one or more criteria can be associated with the one or more feeding parameters. Sensor data can be obtained that describes at least one property of the aquaculture environment. A selected set of feeding parameters can be selected using the obtained sensor data and the obtained feeding parameters. The selected set of feeding parameters can be provided to a feeding control subsystem.

One or more of the following features can be also included. Sensor data related to the effectiveness of the selected set of feeding parameters from one or more sensors that are configured to measure a property of an aquaculture environment can be obtained. Based at least in part on the obtained sensor data, an adjustment for at least one obtained feeding parameter can be determined, and based on the adjustment, at least one obtained feeding parameter can be adjusted. The sensor data can describe at least one of water salinity, dissolved oxygen, temperature, water turbidity and weather conditions. Criteria can be obtained that are associated with at least one obtained feeding parameter, and based on determining that a criterion among the obtained criteria is satisfied, a feeding parameter associated with the criterion can be selected. Adjusting can include evaluating a machine learning model, and the machine learning model can be a reinforcement learning machine learning model or an active learning machine learning model. Based on evaluating an adjustment against one or more policies in a set of policies, the adjustment can be determined to satisfy one or more policies in the set of policies, and based on determining that the adjustment satisfies the one or more policies in the set of policies, and based on the adjustment, at least one feeding parameters can be adjusted.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, executing the meal plan based on the meal configuration data includes: determining the one or more parameters of the meal configuration data; and sending a signal to a feeding mechanism indicating the one or more parameters of the meal configuration data.

In some implementations, the signal is configured to instruct the feeding mechanism how to feed the farmed fish based on the one or more parameters.

In some implementations, adjusting the execution of the meal plan based on the sensor data includes: processing the sensor data using one or more models to generate values associated with one or more determinations; comparing the values with one or more conditions indicated by the meal configuration data; and adjusting the execution of the meal plan based on the one or more conditions indicated by the meal configuration data being satisfied or not satisfied based on the one or more determinations.

In some implementations, the one or more models include a trained neural network model.

In some implementations, the meal configuration data includes a policy that prevents, based on the sensor data, feeding the fish more than a predetermined amount, and, in some cases, that amount can be zero.

In some implementations, the predetermined amount is expressed as a percentage of biomass indicating the biomass of the farmed fish to be fed.

In some implementations, the biomass of the farmed fish is determined by one or more trained models configured to determine a biomass for each fish depicted in one or more visual images.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for the automated feeding of fish.

FIG. 2 is a flow diagram illustrating an example of a process for the automated feeding of fish.

FIG. 3 is a diagram showing an example of a system for executing a meal.

FIG. 4 is a diagram illustrating an example of a computing system used for the automated feeding of fish.

FIG. 5 is a diagram showing an example of a system for the automated feeding of fish.

FIG. 6 is a flow diagram illustrating an example of a process for the automated feeding of fish.

Like reference numbers and designations in the various drawings indicate like elements.

### DETAILED DESCRIPTION

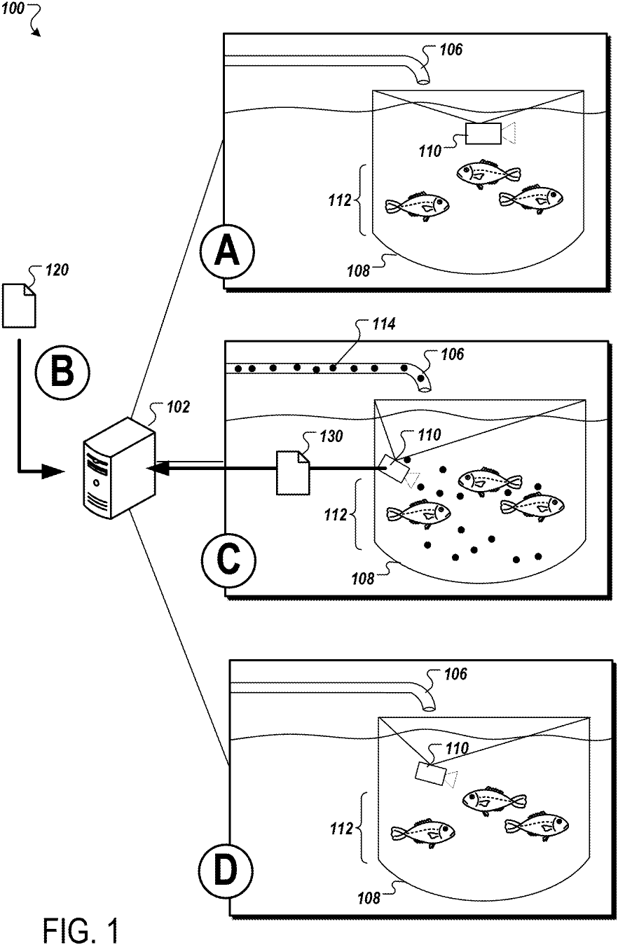

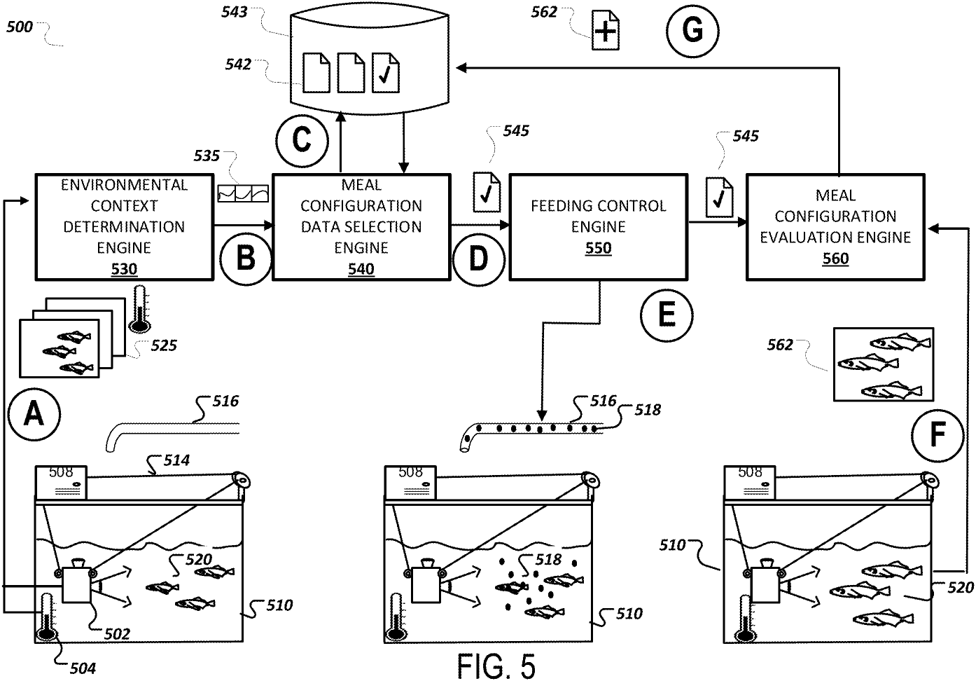

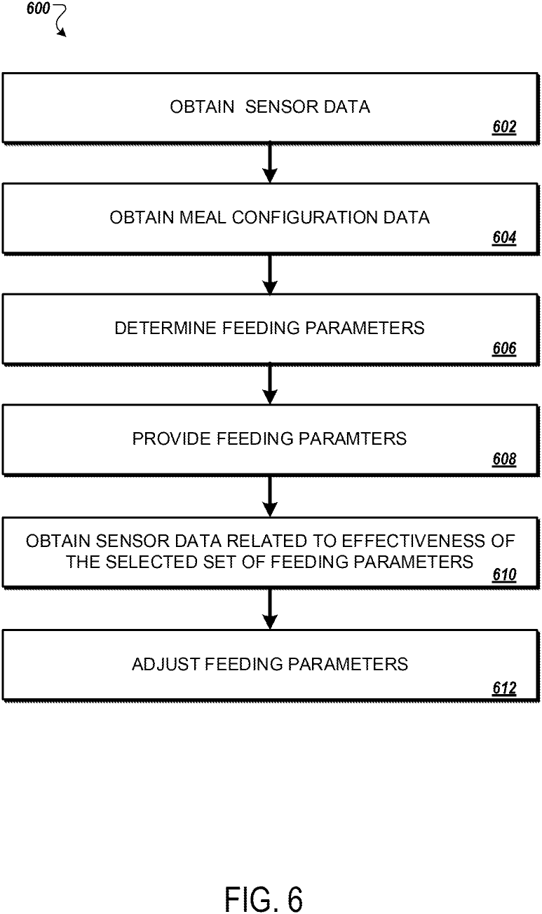

In general, this specification describes an approach for feeding livestock, described in connection with FIGS. 1 to 4, as well as a framework for selecting among alternative meal configuration data using sensor data, described in connection with FIGS. 5 and 6.

In particular, FIG. 1 is a diagram showing an example of a system 100 for the automated feeding of livestock in an aquaculture environment. Aquaculture includes the farming of marine organisms such as fish, crustaceans and mollusks. Aquaculture is important to the health of marine ecosystems, which can suffer from overfishing, through reducing pressure on wild fish populations. Experience indicates over half of all fish and shellfish come from aquaculture, and in the absence of aquaculture, substantial, and perhaps irreversible, strain on marine ecosystems could result.

Properly feeding the livestock is an important and challenging aspect of aquaculture. Underfeeding can cause livestock not to thrive, perhaps resulting in physical harm, and overfeeding results in wasted resource. Following a meal plan can increase the likelihood that livestock receive enough feed to thrive while limiting the amount of wasted feed. In addition, a meal plan can be adjusted dynamically based on factors sensed in real-time such a feed fall-through rate, reducing the amount of wasted feed. Further, a meal plan can be adjusted based on prior outcomes, for example, using reinforcement learning to favor effective aspects of a meal plan.

Returning to FIG. 1., the system 100 includes a control unit 102 configured to control a feeding mechanism 106 based on configuration data 120 and image data 130 collected by imaging device 110. The feeding mechanism 106 provides feed 114, such as fish pellets or other fish food, to fish 112 inside fish pen 108.

The imaging device 110 can be equipped with one or more cameras configured to capture visual images underwater. The imaging device 110 can also be equipped with one or more sensors to provide data to the control unit 102, such as a light sensor and a depth sensor. The imaging device 110 can be communicably connected to the control unit 102 to send the image data 130 to the control unit 102.

The feeding mechanism 106 can include a pipe connecting the pen 108 to a central feeding station that provides the feed 114 to the pen 108. In some implementations, a distributor located at the pen 108 can be used to more evenly distribute the feed 114 within the pen 108. For example, the distributor can move around the surface of the pen 108 while dropping the feed 114 for the fish 112. In some cases, a device can be used to propel the feed 114. For example, a blower that blows air or water with the feed 114 can be used to disperse the feed 114.

In stage A, the feeding mechanism 106 is not yet providing any feed. In stage B, the control unit 102 receives the configuration data 120. The configuration data 120 specifies meal parameters that can include an intensity at which to feed, a rate to increment the intensity of feeding from not feeding to feeding, a required depth of food after a given period of time, a required fraction of fish that are to be fed, and a delay between the current meal plan execution and a subsequent meal plan execution. Other parameters can be specified in the configuration data 120 depending on implementation.

In stage C, the control unit 102 sends a signal to the feeding mechanism 106 to begin a meal based on the configuration data 120. The control unit 102 can send a signal to increment the feeding intensity of the feeding mechanism 106 based on an increment parameter specified in the configuration data 120. The increment parameter can determine the rate at which the feed 114 is progressively provided by the feeding mechanism 106 to the fish pen 108 from an initial feeding intensity specified in the configuration data 120 up to a maximum feeding intensity or until a determined condition is satisfied, such as feed depth.

Each of the initial feeding intensity, maximum feeding intensity, and maximum feed depth can be specified in the configuration data 120. The time between intensity increments can further be specified by the configuration data 120. For example, the feeding intensity can increase by 10 grams per second every minute.

The imaging device 110 sends the image data 130 to the control unit 102. In the example of FIG. 1, the image data 130 is a form of raw data and the control unit 102 processes the raw data in order to determine subsequent actions based on the meal plan in the configuration data 120. By performing processing at the control unit 102 instead of the imaging device 110, the system 100 can enable a lighter and cheaper imaging device 110 that need not be equipped with processing capabilities required for image analysis. Furthermore, the imaging device 110 can use energy that would have been required for image analysis to aid in other actions, such as movement, capturing images, sending images, among others.

In some implementations, the imaging device 110 can move around the pen 108 to obtain one or more images of the fish 112 and the surrounding environment. The imaging device 110 can be equipped with propellers, jets, or other propulsive means to travel within the water of the fish pen 108. The imaging device 110 can be attached to the pen 108 with rope or cable. Lengths of rope or cable used to connect the imaging device 110 to the pen 108 can be elongated or shortened in order to move the imaging device 110 around the pen 108. Instead of, or in addition to, a depth sensor, the length of rope can be monitored in order to determine the effective depth of the imaging device 110.

The control unit 102 receives the image data 130 from the imaging device 110. The image data 130 includes one or more events corresponding to the fish 112. For example, the image data 130 can include an image of a fish. The fish can be one of one or more fish referred to herein as the fish 112. The control unit 102 can analyze the image of the fish using one or more analysis techniques including machine-learning methods. The fish can be identified based on a trained detection model trained to identify fish. The fish can further be identified as currently eating, swimming vertically to swallow a pellet, or swimming with mouth open using the same or a different detection model trained to identify the activity of a fish.

In the example of FIG. 1, the image data 130 includes an image of one or more pellets of the feed 114. The control unit 102 can analyze the image of the feed 114 to identify the one or more pellets. The imaging device 110 can capture an image of the feed 114 dropping below a threshold specified in the configuration data 120. After processing, the control unit 102 can determine, based on the detected feed 114 below the threshold, to send a stop signal to the feeding mechanism 106.

The control unit 102 can determine the depth that the feed 114 drops to by processing the image data 130. For example, the image data 130 can include a depth measurement sent by the imaging device 110 indicating the current depth of the imaging device 110. The depth measurement can be determined using a depth sensor affixed to the imaging device 110. The image data 130 can further include a tilt angle indicating what direction the imaging device 110 is pointed. The control unit 102 can use one or more elements of the image data 130 to determine the actual depth of objects detected within images received from the imaging device 110. The control unit 102 can compare the actual depth of the objects to criteria specified in the configuration data 120.

In stage D, the control unit 102 determines, based at least on the feed 114 falling through to a depth specified in the configuration data 120, to send a stop signal to the feeding mechanism 106. The stop signal is configured to stop the feed 114 being provided to the fish 112 of the fish pen 108.

In some implementations, a depth range can be used to determine whether to increase or decrease feeding. For example, the configuration data 120 can specify a depth range of 5 meters (m) to 15 m. If the control unit 102 detects the feed 114 beyond 15 m, the control unit 102 can send a stop signal to the feeding mechanism 106 configured to stop providing the feed 114 to the fish 112. Similarly, in some implementations, if the control unit 102 does not detect the feed 114 below 5 m, the control unit 102 can send an increase feeding signal to the feeding mechanism 106 configured to increase feeding.

In some implementations, the control unit 102 can decrease feeding based on the depth at which the feed 114 is detected. For example, in a range of 5 m to 15 m, the control unit 102 can detect the feed 114 at 11 m. Based on a predetermined scale that assigns regions of the range to percent feeding reductions, the control unit 102 can determine that the feed 114 at 11 m corresponds to reducing feed by 10 percent and can send a signal to the feeding mechanism 106 configured to reduce feeding by 10 percent.

The control unit 102 can later detect the feed 114 at 12 m and, based on the predetermined scale, send a signal to the feeding mechanism 106 to reduce feeding by 25 percent. The percent reductions can increase until a stop depth. If the feed 114 is detected beyond the stop depth, feed is reduced by 100 percent and the meal is over. In general, any depth range can be used and regions incorporated within can be associated with any feeding reductions specified in the configuration data 120.

In some implementations, detecting the feed 114 can include detecting at least one pellet or item of food. For example, each item of the feed 114 can be detected to determine a depth of the feed. The deepest identified item can be used to determine the depth of the feed 114. In some implementations, depths of one or more items of the feed 114 can be averaged in order to determine the depth of the feed 114. For example, the control unit 102 can detect 5 pellets at depths of 5 m, 5 m, 5 m, 7 m, and 12 m. If averaging is used, the depth of the feed 114 based on the 5 detected pellets can be determined, by the control unit 102, to be 6.8 m.

In some implementations, other metrics are used to determine the depth of the feed 114. For example, each depth associated with each item of food detected can be compared with a reference depth, such as the maximum stop depth, to determine the error between the detected depths and the reference. The differences can be combined to produce a metric, such as a root-mean-square of the differences. The metric can be used to control the effect of outlier detections on the depth calculation for the feed 114.

In some implementations, clustering algorithms can be used to determine the depth of the feed 114. For example, the depth of each item of the feed 114 can be determined by the control unit 102 based on the image data 130. A clustering algorithm, such as k-means clustering, can then be used to cluster a first and a second portion. The first portion can be used to determine the depth of the feed 114 and the second portion can be excluded from the calculation as outliers.

In some implementations, other outlier detection methods can be used to exclude outliers from a depth of the feed 114 calculation. For example, the depth of each item of the feed 114 can be determined by the control unit 102 based on the image data 130. Using any number of outlier detection methods including z-score or extreme value analysis, probabilistic and statistical modeling, linear regression models, proximity based models, information theory models, and high dimensional outlier detection methods, the control unit 102 can determine one or more outliers to exclude in order to determine the depth of the feed 114.

In some implementations, the control unit 102 detects one or more other events based on the image data 130. For example, the control unit 102 can detect a fraction of total feeding. The fraction of total feeding can be determined based, in part, on determining the ratio of fish with open mouths to fish with closed mouths using one or more detection models as described herein. The fish with open mouths can be considered eating while the fish with closed mouths can be considered not eating. The control unit 102 can determine whether to increase feeding, decrease feeding, or stop feeding based, at least in part, on the fraction of total feeding and a goal fraction of total feeding specified in the configuration data 120.

In some implementations, the control unit 102 performs other actions in response to detecting one or more events in the image data 130. For example, the control unit 102 can determine that the feed 114 does not drop to a predetermined depth. This can be the result of the fish 112 near the surface of the pen 108 eating the food before it drops to the predetermined depth. The configuration data 120 can specify that the feed 114 drop to a predetermined depth in order to ensure enough food is provided to the fish 112. The control unit 102, using both the image data 130 and the configuration data 120, can send a signal to the feeding mechanism 106 that is configured to increase a feeding intensity in order to satisfy a depth of food requirement specified in the configuration data 120. A control algorithm such as a proportional-integral-differential (PID) controller can be used to dynamically adjust the feed rate in order to accomplish feeding within a given depth range.

For another example, the control unit 102 can determine that the feed 114 drops below a predetermined depth. The configuration data 120 can specify that the feed 114 not drop to, or below, a predetermined depth. If the control unit 102 determines that the feed 114 satisfies a drop threshold, the control unit 102 can configure and send a signal to the feeding mechanism 106 to reduce the feed 114 or stop the feed 114 being provided to the fish 112.

In some implementations, the control unit 102 determines one or more values corresponding to one or more parameters of the configuration data 120 and, in response, determines a subsequent action based on the one or more values. For example, the control unit 102 can determine that the feeding rate of the fish pen 108 is lower than a predetermined threshold and that the feed drop depth is also lower than a predetermined threshold. The control unit 102 can then, based on the determined feed rate and determined feed drop depth compared to corresponding parameters in the configuration data 120, configure and send a signal to the feeding mechanism 106 to provide more feed.

In another example, the control unit 102 can determine that the feeding rate of the fish pen 108 is lower than a predetermined threshold and that the feed drop depth is higher than a predetermined threshold. This can be caused by the fish 112 being full and not eating and therefore the feed 114 dropping further. The control unit 102 can then, based on the determined feed rate and determined feed drop depth compared to corresponding parameters in the configuration data 120, configure and send a signal to the feeding mechanism 106 to reduce the feed 114 or stop the meal. In this way, a single value associated with a parameter of the configuration data 120 can be interpreted by the control unit 102 according to one or more other values determined by the control unit 102.

In some implementations, the imaging device 110 can pre-process images obtained by the imaging device 110. For example, the imaging device 110 can process obtained images and send corresponding processed data to the control unit 102. In this way, the imaging device 110 can reduce processing requirements of the control unit 102, reduce necessary bandwidth to communicate with the control unit 102, as well as reduce energy requirements for the control unit 102.

In some implementations, one or more additional imaging devices can be used to obtain images. For example, the imaging device 110 can represent any number of imaging devices that can be employed within the pen 108 to capture images.

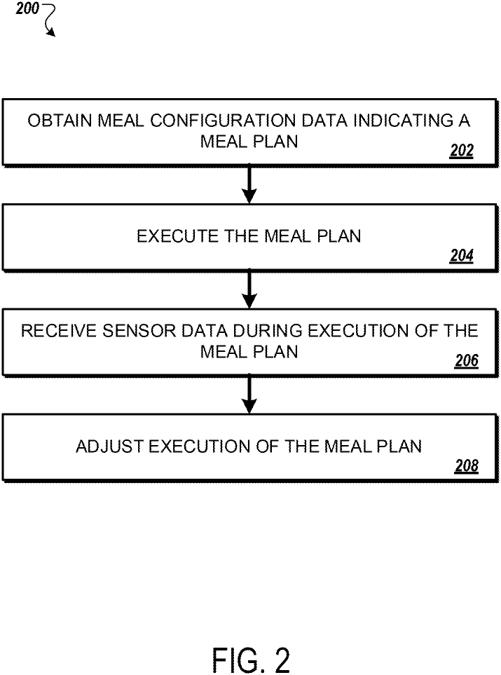

FIG. 2 is a flow diagram illustrating an example of a process 200 for the automated feeding of fish. The process 200 can be performed by one or more electronic systems, for example, the system 100 of FIG. 1.

The process 200 includes obtaining meal configuration data indicating a meal plan (202). For example, as shown in stage B of FIG. 1, the control unit 102 can receive the configuration data 120. Table 1 shows an example implementation of parameters and associated values that can be included in the configuration data 120.

Table 1

meal_config: { label: “MAIN MEAL” initial_intensity_grams_per_sec: 150 increment_intensity_grams_per_sec: 10 time_between_intensity_increment_in_minutes: 1 min_depth_in_m: 6 fall_through_depth_in_m: 18 fall_thru_score_threshold: 0.5 feed_adjustment_proportional_gain: 0.25 fraction_of_total_feeding: 0.8 delay_to_next_meal_in_minutes: 60 }

In some implementations, the configuration data 120 can include one or more adjustable parameters. For example: the configuration data 120 can include an “initial_intensity_grams_per_sec” parameter that can control how much of the feed 114 is provided to the fish 112 at the beginning of a meal; the configuration data 120 can include an "increment_intensity_grams_per_sec" parameter that can control how much the rate at which the feed 114 is provided to the fish 112 is increased; the configuration data 120 can include a "time_between_intensity_increment_in_minutes" parameter that can control the rate at which the feed 114 is incremented by a determined increment value (e.g., ‘increment_intensity_grams_per_sec’); the configuration data 120 can include a "min_depth_in_m" parameter that can specify the minimum depth of the feed 114 or the minimum depth of a sensor, such as the imaging device 110; the configuration data 120 can include a “fall_through_depth_in_m” parameter that can specify the depth that the feed 114 can reach as it falls in the water, as sensed by a camera; the configuration data 120 can include a "fall_thru_score_threshold" that can control the amount of the feed 114 that falls through and prevent excess fall through, as sensed by the camera; the configuration data 120 can include a "feed adjustment_proportional_gain" that can control the rate at which the feed 114 is adjusted when adjustments are required to satisfy parameters of the configuration data 120; the configuration data 120 can include a “fraction_of_total_feeding” that can specify the amount of fish of the fish 112 that should be feeding during a meal where a trained model can detect fish with mouths open as fish that are feeding and fish with mouths closed as fish that are not feeding; the configuration data 120 can include a "delay_to next_meal_in minutes" that can specify the amount of time between the current meal, such as the 'Main Meal' and a subsequent meal where the delay can be adjusted based on the amount of food provided to the fish. The configuration data 120 can also include a minimum feeding time and a maximum feeding time. The configuration data 120 can further include compound parameters, such as reducing the feeding rate by a given increment if the fall through at a configured depth exceeds a configured value.

The process 200 includes executing the meal plan (204). For example, the control unit 102 can send a signal to the feeding mechanism 106 to begin a meal based on the configuration data 120. The configuration data 120 can include an “initial_intensity_grams_per_sec” parameter indicating at what initial rate the feed 114 should be provided to the fish 112.

The process 200 includes receiving sensor data during execution of the meal plan (206). For example, the control unit 102 can use input from one or more sensors, such as the imaging device 110, to determine values of one or more parameters and then compare the values determined based on the sensor data to the obtained parameters in the configuration data 120.

The process 200 includes adjusting execution of the meal plan (208). For example, the control unit 102 can compare a value of “fall_through_depth_in_m” specified in the configuration data 120 to a determined feed depth. After determining that the feed has reached a depth deeper than the value of “fall_through_depth_in_m” specified in the configuration data 120, the control unit 102 can send a signal to the feeding mechanism 106 to decrease or stop feeding.

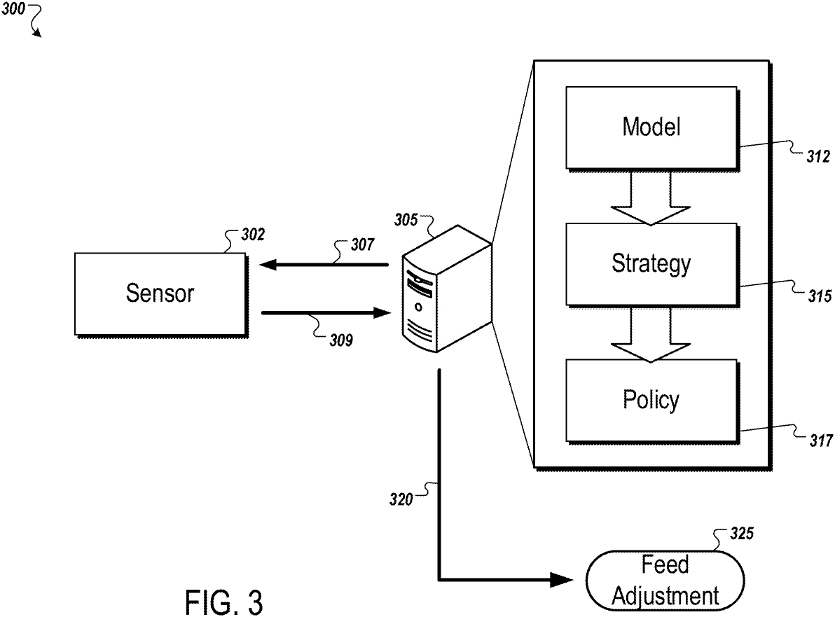

FIG. 3 is a diagram showing an example of a system 300 for executing a meal. The system 300 includes a sensor 302 that communicates with a control unit 305. The system 300 can be used to implement the techniques described herein. For example, the imaging device 110 could be an example of the sensor 302 and the control unit 102 could be an example of the control unit 305.

In some implementations, the sensor 302 can be attached to, or a part of, a moving device. For example, the sensor 302 can be a camera attached to a submersible patrol device configured to move underwater. The sensor 302 can be a light sensor, proximity sensor, or other electronic apparatus configured to collect data. The sensor 302 can include computer hardware configured to obtain and send data.

The control unit 305 can send a first communication 307 to the sensor 302. In some cases, the first communication 307 can include details of a patrol task. For example, the control unit 305 can send a signal instructing the sensor 302 to move to a specific area within a fish pen, such as the fish pen 108. The control unit 305 can send a signal instructing the sensor 302 to obtain data from a particular region, such as images from a particular depth or of a location within a fish pen.

In some implementations, the control unit 305 can control a type of movement for the sensor 302. For example, the control unit 305 can send a signal instructing the sensor 302 to move to a specific depth or can indicate allowable depths within which the sensor 302 can patrol. For another example, the control unit 305 can send a signal instructing the sensor 302 to move at a particular speed.

In some implementations, the control unit 305 can control what data is obtained by the sensor 302. For example, the control unit 305 can send a signal instructing the sensor 302 to capture visual images at a specific frequency for a particular amount of time. This can be configured to coincide with other events, such as feeding events where more image data can be useful to have.

In response to the first communication 307, the sensor 302 can send sensor data 309 to the control unit 305. The sensor data 309 can include visual images obtained by the sensor 302, such as the image data 130. The sensor data 309 can include other data forms as well depending on the first communication 307. For example, the sensor data 309 can include one or more determinations generated by the sensor 302 or a device communicably connected to the sensor 302.

In some implementations, the sensor data 309 can include other forms of data. For example, the sensor data 309 can include feedback from various feeding mechanisms, such as the feeding mechanism 106. The sensor data 309 can indicate the amount of feed currently being provided or other status information such as an operational status of a device to provide food to an area, such as the fish pen 108.

The control unit 305 can process the sensor data 309 based on data pre-obtained by the control unit 305. In some cases, the pre-obtained data can include the configuration data 120. The pre-obtained data in the system 300 includes a model 312, a strategy 315, and a policy 315. In some implementations, the configuration data 120 can include one or more elements of the model 312, the strategy 315, and the policy 315.

The model 312 processes the sensor data 309 to make one or more determinations based on the sensor data 309. For example, if the sensor data 309 includes an image of a fish, the model 312 can detect the occurrence of the fish within the sensor data 309. The model 312 can be a collection of one or more trained models configured to detect particular occurrences in the feeding scenarios discussed herein. For example, the model 312 can be used to detect occurrences of fish with mouths open or a number of pellets within one or more images of the sensor data 309.

In some implementations, the model 312 includes a biomass estimation. For example, one or more trained models of the model 312 can be configured to determine a biomass estimation for a fish based on one or more images of the fish. In some implementations, an untrained model is provided images of fish with associated biomasses. The untrained model can be trained by adjusting one or more of its parameters to generate output that matches the associated biomasses. In some cases, truss lengths between parts of a detected fish are used as input to a model for predicting biomass. For example, the processing techniques described in U.S. App. No. 16/734,661, filed Jan. 6, 2020 and entitled “Fish Biomass, Shape, Size, or Health Determination”, which is incorporated herein by reference, can be used in processing by the control unit 305.

The output of the model 312 can be used to interpret conditions of the strategy 315 as well as the policy 317. For example, the model 312 can detect that a fish pen has been provided 3 percent of its collective biomass in feed. The strategy 315 can indicate, for example, based on feed drop depth, that feeding should continue. The policy 317 can include a max feed amount to stop feeding when necessary, such as when the total feed amount reaches a certain percentage, e.g., 3 percent, of a fish pen’s biomass.

Even though the parameters of the strategy 315 can require additional feeding, if the max feed amount in the policy 317 is reached, the control unit 305 can send a signal to stop feeding. In this case, the policy 317 can be used to ensure that fish are not fed too much or too little. The policy 317 can include maximum and minimum feeding rates as well as maximum feeding amounts in weight and as a percentage of biomass.

Table 2 shows an example implementation of parameters and associated values that can be included in the policy 317. In some implementations, the policy 317 can be included in the configuration data 120.

Table 2

policy_config: { min_pen_feeding_rate_kg_per_min: 2 max_pen_feeding_rate_kg_per_min: 40 max_pen_feeding_amount_percent_biomass: 3 pen_total_feed_hard_limit_in_kg: 8000 }

In some implementations, the policy 317 can include one or more adjustable parameters. For example: the policy 317 can include a “min_pen_feeding_rate_kg_per_min” that can prevent a given feeding strategy from reducing a feeding rate below a predetermined value specified by the parameter; the policy 317 can include a “max_pen_feeding_rate_kg_per_min” that can prevent a given feeding strategy from increasing a feeding rate above a predetermined value specified by the parameter; the policy 317 can include a “max_pen_feeding_amount_percent_biomass” that can prevent a given feeding strategy from continuing to feed a group of fish an amount of feed more than a percentage of biomass specified by the parameter; the policy 317 can include a “pen_total_feed_hard_limit_in_kg” that can prevent a given feeding strategy from continuing to feed a group of fish an amount of feed more than an amount of feed specified by the parameter.

In some implementations, parameters of the strategy 312 and the policy 317 can be adjusted to change the automated feeding process. For example, as discussed herein with respect to the configuration data 120, elements of the control unit 305 including the model 312, the strategy 315, and the policy 317 can be pre-obtained by the control unit 305 in order to process the sensor data 309. Output of the model 312 can be used to determine whether one or more conditions in the strategy 315 are met. These conditions are discussed herein with respect to the configuration data 120. Before adjusting the meal, the control unit 305 can check one or more conditions of the policy 317.

In some implementations, the conditions of the policy 317 can be given higher priority than conditions of the strategy 315. For example, when, based on one or more determinations of the model 312, a condition of the strategy 315 would increase feeding and a condition of the policy 317 would stop feeding, the control unit 305 can give the policy 317 high priority by stopping the feeding instead of increasing feeding.

The control unit 305 can determine, based on one or more outputs of the model 312 and conditions of the strategy 315 and the policy 317 a feed adjustment 325. A feed adjustment signal 320 indicating the feed adjustment 325 can be sent to a relevant feeding mechanism configured to adjust the feed provided to fish, such as the fish within the fish pen 108.

In some implementations, the control unit 305 can determine that a maximum feed amount has been reached. For example, regardless of conditions within the strategy 315, a max feeding condition of the policy 317 can be satisfied. In this case, the control unit 305 can determine to stop feeding. The feed adjustment 325 can be configured to indicate that feeding should be stopped and a corresponding feed adjustment signal 320 can be sent to a feeding mechanism.

In some implementations, the control unit 305 can determine one or more conditions of the strategy 315 or the policy 317 without processing data in the model 312. For example, an amount of feed provided to fish can be sent by the sensor 302 and compared with a condition in the policy 317 without further processing by the model 312. The sensor 302 in this case can include a sensor fixed to a feeding mechanism, such as the feeding mechanism 106, configured to measure the feed being provided to fish. As previously mentioned, although depicted as a singular sensor for illustration purposes, the sensor 302 can include more than one sensor configured to obtain data.

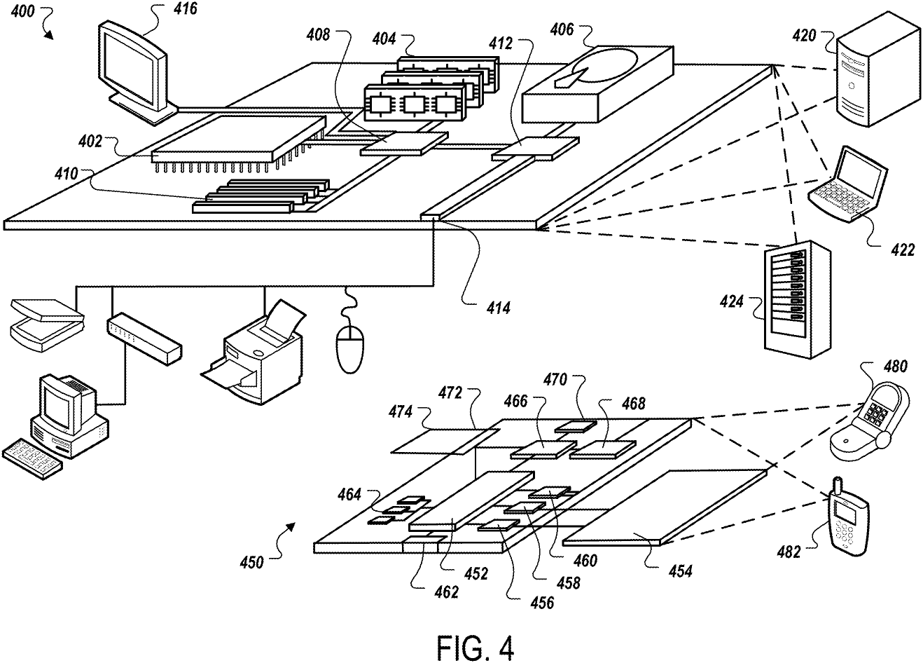

FIG. 4 is a diagram illustrating an example of a computing system used for the automated feeding of fish. The computing system includes computing device 400 and a mobile computing device 450 that can be used to implement the techniques described herein. For example, one or more components of the system 100 or the system 300 could be an example of the computing device 400 or the mobile computing device 450, such as a computer system implementing the control unit 102, the feeding mechanism 106, the imaging device 110, the control unit 305, or the sensor 302.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and can be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses can be used, as appropriate, along with multiple memories and types of memory. In addition, multiple computing devices can be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 can also be another form of computer-readable medium, such as a magnetic or optical disk.

The storage device 406 is capable of providing mass storage for the computing device 400. In some implementations, the storage device 406 can be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine readable mediums (for example, the memory 404, the storage device 406, or memory on the processor 402).The high-speed interface 408 manages bandwidth-intensive operations for the computing device 400, while the low-speed interface 412 manages lower bandwidth-intensive operations. Such allocation of functions is an example only. In some implementations, the high speed interface 408 is coupled to the memory 404, the display 416 (e.g., through a graphics processor or accelerator), and to the high-speed expansion ports 410, which can accept various expansion cards (not shown). In the implementation, the low-speed interface 412 is coupled to the storage device 406 and the low-speed expansion port 414. The low-speed expansion port 414, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 400 can be implemented in a number of different forms, as shown in the figure. For example, it can be implemented as a standard server 420, or multiple times in a group of such servers. In addition, it can be implemented in a personal computer such as a laptop computer 422. It can also be implemented as part of a rack server system 424. Alternatively, components from the computing device 400 can be combined with other components in a mobile device, such as a mobile computing device 450. Each of such devices can include one or more of the computing device 400 and the mobile computing device 450, and an entire system can be made up of multiple computing devices communicating with each other.

The mobile computing device 450 includes a processor 452, a memory 464, an input/output device such as a display 454, a communication interface 466, and a transceiver 468, among other components. The mobile computing device 450 can also be provided with a storage device, such as a micro-drive or other device, to provide additional storage. Each of the processor 452, the memory 464, the display 454, the communication interface 466, and the transceiver 468, are interconnected using various buses, and several of the components can be mounted on a common motherboard or in other manners as appropriate.

The processor 452 can execute instructions within the mobile computing device 450, including instructions stored in the memory 464. The processor 452 can be implemented as a chipset of chips that include separate and multiple analog and digital processors. The processor 452 can provide, for example, for coordination of the other components of the mobile computing device 450, such as control of user interfaces, applications run by the mobile computing device 450, and wireless communication by the mobile computing device 450.

The processor 452 can communicate with a user through a control interface 458 and a display interface 456 coupled to the display 454. The display 454 can be, for example, a TFT (Thin-Film-Transistor Liquid Crystal Display) display or an OLED (Organic Light Emitting Diode) display, or other appropriate display technology. The display interface 456 can include appropriate circuitry for driving the display 454 to present graphical and other information to a user. The control interface 458 can receive commands from a user and convert them for submission to the processor 452. In addition, an external interface 462 can provide communication with the processor 452, so as to enable near area communication of the mobile computing device 450 with other devices. The external interface 462 can provide, for example, for wired communication in some implementations, or for wireless communication in other implementations, and multiple interfaces can also be used.

The memory 464 stores information within the mobile computing device 450. The memory 464 can be implemented as one or more of a computer-readable medium or media, a volatile memory unit or units, or a non-volatile memory unit or units. An expansion memory 474 can also be provided and connected to the mobile computing device 450 through an expansion interface 472, which can include, for example, a SIMM (Single In Line Memory Module) card interface. The expansion memory 474 can provide extra storage space for the mobile computing device 450, or can also store applications or other information for the mobile computing device 450. Specifically, the expansion memory 474 can include instructions to carry out or supplement the processes described above, and can include secure information also. Thus, for example, the expansion memory 474 can be provide as a security module for the mobile computing device 450, and can be programmed with instructions that permit secure use of the mobile computing device 450. In addition, secure applications can be provided via the SIMM cards, along with additional information, such as placing identifying information on the SIMM card in a non-hackable manner.

The memory can include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 can communicate wirelessly through the communication interface 466, which can include digital signal processing circuitry in some cases. The communication interface 466 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication can occur, for example, through the transceiver 468 using a radio frequency. In addition, short-range communication can occur, such as using a Bluetooth, Wi-Fi, or other such transceiver (not shown). In addition, a GPS (Global Positioning System) receiver module 470 can provide additional navigation- and location-related wireless data to the mobile computing device 450, which can be used as appropriate by applications running on the mobile computing device 450.

The mobile computing device 450 can also communicate audibly using an audio codec 460, which can receive spoken information from a user and convert it to usable digital information. The audio codec 460 can likewise generate audible sound for a user, such as through a speaker, e.g., in a handset of the mobile computing device 450. Such sound can include sound from voice telephone calls, can include recorded sound (e.g., voice messages, music files, among others) and can also include sound generated by applications operating on the mobile computing device 450.

The mobile computing device 450 can be implemented in a number of different forms, as shown in the FIG. 4. For example, it can be implemented as a cellular telephone 480. It can also be implemented as part of a smart-phone 482, personal digital assistant, or other similar mobile device.

While FIGS. 1 to 4 described feeding livestock, such as fish within an aquaculture environment, using a meal plan, FIGS. 5 and 6 describe a framework for selecting meal configuration data in response to sensor data, and making improvements to meal configuration data using techniques such as reinforcement learning and active learning.

Sensors included in an aquaculture environment can aid in the care and feeding of the livestock. Sensors can provide measurements that are used to monitor environmental conditions such as light, temperature and barometric pressure. The measurements can also be used when producing information such as estimates of the population and biomass of livestock. Sensors can be attached in fixed positions, or attached to one or more rigs that patrol the environment.

Sensor data can be used to improve approaches to feeding. For example, larger biomasses tend to consume more feed, so an accurate biomass estimation, determined from sensor data, can be used to adjust aspects of a meal plan. In another example, falling barometric pressure can signal degrading weather conditions, and some aquatic livestock reduce feed consumption in poor weather. Thus, changes in barometric pressure can influence the selection of meal configuration data.

In addition, while meal configuration data can represent the best current known approach to feeding under various sensed conditions, in some cases, the meal configuration data can be improved in response to monitored metrics. The framework can perturb a selected meal configuration data, for example, by slightly increasing or decreasing the feed rate, monitor the results, and adjust the meal plan when results are improved, as described further below. The perturbations can be limited by policies that ensure the livestock receive enough feed to thrive.

FIG. 5 is a diagram showing an example of a system for the automated feeding of fish. The system 500 can include an enclosure 510 with a winch system 514 and one or more camera subsystems 502 each containing one or more cameras, including stereo cameras. The system 500 can also include a feeder mechanism 516 and one or more sensor devices 504 that monitor properties of the environment. The system can further include an environmental context determination engine 530, a meal configuration data selection engine 540, a meal configuration data storage subsystem 543, a feeding control engine 550 and a meal configuration evaluation engine 560.

The enclosure 510 can enclose livestock that can be aquatic creatures, such as fish 520, which swim freely within the confines of the enclosure 510. In some implementations, the aquatic livestock 520 stored within the enclosure 510 can include finfish or other aquatic lifeforms. The livestock 520 can include, for example, juvenile fish, koi fish, sharks, salmon, bass, or crustaceans, e.g., shrimp, to name a few examples.

In addition to the aquatic livestock, the enclosure 510 contains water, e.g., seawater, freshwater, or rainwater, although the enclosure can contain any fluid that is capable of sustaining a habitable environment for the aquatic livestock.

In some implementations, the system 500 can be anchored to a structure such as a pier, dock, or buoy. For example, instead of being confined within the enclosure 510, the livestock 520 can be free to roam a body of water, and the system 500 can monitor livestock within a certain area of the body of water without the enclosure 510.

The winch subsystem 508 can move the camera subsystem 502 in a patrol pattern, e.g., up and down to different depths in the enclosure 510. For example, the camera subsystem 502 can patrol up and down within the enclosure 510 while it monitors fish feeding. The winch subsystem 508 can include one or more motors, one or more power supplies, and one or more pulleys to which the cord 514, which suspends the camera subsystem 502, is attached. A pulley is a machine used to support movement and direction of a cord, such as cord 514. Although the winch subsystem 508 includes a single cord 514, any configuration of one or more cords and one or more pulleys that allows the camera subsystem 502 to move and rotate, as described herein, can be used.

The winch subsystem 508 can activate one or more motors to move the cord 514. The cord 514, and the attached camera subsystem 502, can be moved along the x, y, and z-directions, to a position corresponding to the instruction. A motor of the winch subsystem 108 can be used to rotate the camera subsystem 502 to adjust the horizontal angle and the vertical angle of the sensor subsystem. A power supply can power the individual components of the winch subsystem. The power supply can provide AC and DC power to each of the components at varying voltage and current levels. In some implementations, the winch subsystem can include multiple winches or multiple motors to allow motion in the x, y, and z-directions.

Each camera subsystem 502 can include one or more image capture devices that can point in various directions, such as up, down, to any side, or at other angles. Each camera subsystem 502 can take images using any of its included imaging devices, and an enclosure 510 can contain multiple camera subsystems 502.

A camera subsystem 502 can provide image data 525, which can be individual image data or video image data, represented in any appropriate format. For individual images, formats can include JPEG, TIFF, BMP, raw, etc. For video image data, formats can include MP4, MOV, WAV, AVI, etc. The image data can be provided as sensor data to an environmental context determination engine 530.

Sensor devices 504 in the enclosure 510, or in the vicinity of the enclosure 510, can monitor environmental conditions and provide additional sensor data 525. Examples of sensor devices can include thermometers for measuring the temperature of water or air, barometers for measuring barometric pressure, salinity detectors for measuring the salt concentration of water, and so on.

The feeding mechanism 516 can include a pipe connecting the enclosure 510 to a central feeding station that provides the feed 518 to the enclosure 510. In some implementations, a distributor located at the enclosure 510 can be used to more evenly distribute the feed 518 within the enclosure 510. For example, the distributor can move around the surface of the enclosure 510 while dropping the feed 518 for the fish 520. In some cases, a device can be used to propel the feed 518. For example, a blower that blows air or water with the feed 518 can be used to disperse the feed 518.

At a first time period, in stage A, sensors, such as the camera subsystem 502 and a thermometer 504, provides sensor data 525 to the environmental context determination engine 530.

In stage B, the environmental context determination engine 530 can receive sensor data 525 such as image and temperature data and applies analysis techniques such as computer vision models such as image classification, object detection, object tracking, etc., to produce environment data 535 that describes the environment.

Environmental data 535 can include raw sensor data, such as water salinity, dissolved oxygen, temperature, water turbidity, weather conditions, etc., and data computed by the environmental context determination engine such as biomass estimations.

Environmental data 535 can be encoded in any suitable format. For example, a structured text format, such as Extensible Markup Language (XML) can be used to encode environmental data 535, with tags corresponding to the various categories of data included in the environmental data 535.

In stage C, the meal configuration data selection engine 540 can use the environmental data 535 to select meal configuration data 542 from meal configuration data storage subsystem 543.

The meal configuration data storage subsystem 543 can an appropriate data storage subsystem such as a relational database, an unstructured database, a file system, and so on.

Meal configuration data as previously illustrated in Table 1 can be augmented with information describing environmental context criteria. The environmental context criteria can be expressed as rules, such as Boolean expressions or as assertions.

Table 3 illustrates an example of environmental criteria expressed as assertions.

Table 3

meal_config: { label: “MAIN_MEAL” { temp: 5-10C initial_intensity_grams_per_sec: 150 increment_intensity_grams_per_sec: 10 time_between_intensity_increment_in_minutes: 1 } { temp: TRUE initial_intensity_grams_per_sec: 160 increment_intensity_grams_per_sec: 12 time_between_intensity_increment_in_minutes: 1 } min_depth_in_m: 6 fall_through_depth_in_m: 18 fall_thru_score_threshold: 0.5 feed_adjustment_proportional_gain: 0.25 fraction_of_total_feeding: 0.8 delay_to_next_meal_in_minutes: 60 }

In this example, the MAIN_MEAL configuration has two subsections, one applying when the measured temperature is between 5 and 10 degrees Celsius, and a default, denoted with a TRUE value, that applies when no prior criteria are satisfied. Parameters that are not marked with criteria can apply to all meal configurations, regardless of the environmental data 535.

The meal configuration data selection engine 540 can compare the environmental data 535 to the environmental context criteria associated with the configuration data stored in the meal configuration data storage subsystem 543 and select parameters and values for which the criteria are satisfied. The result can be a selected meal configuration 545.

In some implementations, the meal configuration data selection engine 540 can use trained machine learning models to select meal configuration. The machine learning model can be a classification model that selects among meal configuration parameters or regression models that determine values for the parameters.

In stage D, the system 500 can pass the selected meal configuration 545 to a feeding control engine 550 which is configured to control a feeding mechanism 516. As described previously, the configuration data 545 specifies meal parameters that can include an intensity at which to feed, a rate to increment the intensity of feeding, a required depth of food after a given period of time, a required fraction of fish that are to be fed, and a delay between the current meal plan execution and a subsequent meal plan execution. Other parameters can be specified in the configuration data.

In stage E, the feeding control engine 550 can send a signal to the feeding mechanism 516 to begin a meal, where the feeding pattern is guided by the selected configuration data 545. The feeding control engine 550 can send a signal to increment the feeding intensity of the feeding mechanism 516 based on an increment parameter specified in the selected configuration data 545. The increment parameter can determine the rate at which the feed 518 is progressively provided by the feeding mechanism 516 to the fish pen 510 from an initial feeding intensity specified in the configuration data 545 up to a maximum feeding intensity or until a determined condition is satisfied, such as feed depth.

In addition, the feeding control engine 550 can send the selected configuration data 545 to the meal configuration evaluation engine 560 where it can be used to evaluate the effectiveness of the meal configuration, as described below.

In stage F, the system 500 can gather data that reflect the effectiveness of feeding - i.e., metrics 562 that reflect the success of the meal plan. Some data, such as the fall through rate of the pellets below a given depth , can be gathered while feeding the fish. Other data, such as the total biomass and feed conversion ratio (which measures the fraction of feed that is converted into fish biomass), can be measured over longer time frames. Other metrics can include the rate of growth of the biomass, the size distribution of the livestock, the change (increase or decrease) of the population, etc.

The feeding effectiveness metrics can be encoded in any suitable format, e.g., a structured text format such as XML. The feeding effectiveness metrics 562 can be delivered to the meal configuration evaluation engine 560.

The meal configuration evaluation engine 560 can evaluate the effectiveness of the configuration data 545, delivered by the feeding control engine 550 in stage E, using the feeding effectiveness metrics 562. The meal configuration evaluation engine 560 can further determine modified configuration data 565 that can include one or more additions, deletions or adjustments to meal configuration data previously stored in the meal configuration data storage subsystem 543.

In stage G, the meal configuration evaluation engine 560 can deliver the modified configuration data 565 to the configuration data storage subsystem 543. In response, the configuration data storage subsystem 543 can adjust the stored configuration data 542 previously stored, add to it, or delete all or part of it.

FIG. 6 is a flow diagram illustrating an example of a process for the automated feeding of fish. For convenience, the process 600 will be described as being performed by a system for the automated feeding of fish in an aquaculture environment, e.g., the system for the automated feeding of fish of FIG. 5, appropriately programmed to perform the process.

In operation 602, the system obtains sensor data from one or more sensors associated with an aquaculture environment. The sensor data can be obtained over a wired connection such as PCI-E or Ethernet or over a wireless network that uses protocols such as 802.11 g or over a cellular data connection.

In operation 604, the system can obtain meal configuration data. The meal configuration data can be obtained using conventional data retrieval techniques such as Structured Query Language (SQL) queries to retrieve data from a relational database, or file system calls to retrieve data stored in files from a file system.

In operation 606, the system determines feeding parameters. In some implementations, the system uses the sensor data obtained in operation 602 to evaluate one or more environmental context criteria associated with the meal configuration data. The system can determine, for parameters included in the meal configuration data that have associated criteria, whether the environmental context criteria are satisfied. In cases where multiple environmental context criteria relating to the same parameter are satisfied, the system can use a conflict resolution method, such selecting the environmental context criteria with a highest associated priority, selecting the first parameter for which the environmental context criteria are satisfied, or selecting randomly among the parameters for which the environmental context criteria are satisfied.

In some implementations, the system can perturb one or more feeding parameters, allowing the system to determine whether alternate feeding configurations produce superior results to the existing configuration. For example, the system can randomly increase or decrease a feeding parameter by an amount that does not exceed a configured threshold. For example, a threshold might specify that a parameter cannot be perturbed by more than a certain percentage, such as 1%, 2%, etc.

In some implementations, the system can also implement policies that enforce guardrails to ensure that a feeding parameter is not larger or smaller than a configured value or ratio. For example, a policy can indicate that the feeding rate cannot be below 120 grams per minute or above 180 grams per minute. In another example, a policy can indicate that the ratio of the estimated biomass (measured in kilograms) to the feed rate (measured in grams per minute) does not exceed a configured threshold. In cases where a feeding would exceed a value defined in a policy, the system can select a value closest to the value in the policy without exceeding that value.

In operation 608, the system provides the feeding parameters to a feeding control engine. The feeding parameters can be provided over a wired (e.g., PCI-E) or wireless (e.g., cellular) connection.

In operation 610, the system obtains sensor data related to the effectiveness of the selected set of feeding parameters from one or more sensors associated with an aquaculture environment. The sensor data can be obtained using a wired connection such as PCI-E or Ethernet or over a wireless network that uses protocols such as 802.11 g or over a cellular data connection. The sensor data can include images obtained from the camera subsystem. Such images can be used by the system to determine estimates of biomass (as described previously), estimates of livestock population, and so on.

In operation 612, the system can adjust feeding parameters. The system can use a reinforcement learning (RL) machine learning model that takes as input the configuration data and the sensor data that reflect the effectiveness of the selected set of feeding parameters. In some implementations, the RL model may aggregate data across multiple pens to inform the adjustments in any given pen. The RL model can reward increases in biomass, livestock population and FCR, while penalizing decreases in biomass, FCR and livestock population. The result of evaluating the RL model can be adjustments in one or more feeding parameters or the selection of different feeding strategies. The adjusted feeding parameters can then be stored in meal configuration data storage subsystem.

In some implementations, the system can evaluate a proposed adjustment against one or more policies, such as the policies described in reference to operation 606. If the system determines that a proposed adjustment satisfies the policies, the proposed adjustment can proceed; if the system determines that a proposed adjustment does not satisfy the policies, the system can determine that the adjustment should not occur. For example, if a proposed adjustment would result in a feeding rate below a minimum feeding rate in a policy, the system can determine that the adjustment should not occur.

While this specification has largely described determining feeding in an aquaculture environment, feeding within an agriculture environment can also be automated using the techniques described in this specification. For example, the sensor data in an agriculture environment can include air temperature, humidity, wind speed, rain, snow, air clarity, etc. The effectiveness metrics can include biomass size, population size, feed conversion ratio, etc. The feed can be selected for the livestock being cultivated. A number of implementations have been described. Nevertheless, it will be understood that various modifications can be made without departing from the spirit and scope of the disclosure. For example, various forms of the flows shown above can be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what can be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats can be substituted. For instance, an HTML file can be replaced by an XML, JSON, plain text, or other types of files. Moreover, where a table or hash table is mentioned, other data structures (such as spreadsheets, relational databases, or structured files) can be used.

Particular embodiments of the invention have been described. Other embodiments are within the scope of the following claims. For example, the steps recited in the claims can be performed in a different order and still achieve desirable results.

What is claimed is:

1. A computer-implemented method comprising:
obtaining meal configuration data relating to feeding livestock in an aquaculture environment including: (i) one or more feeding parameters relating to feeding farmed livestock, and (ii) one or more criteria, each of the one or more criteria associated with the one or more feeding parameters;
obtaining sensor data that describes at least one property of the aquaculture environment;
selecting, using the obtained sensor data and the obtained feeding parameters, a selected set of feeding parameters; and
providing the selected set of feeding parameters to a feeding control subsystem.

2. The computer-implemented method of claim 1 further comprising:
obtaining sensor data related to effectiveness of the selected set of feeding parameters from one or more sensors that are configured to measure a property of aquaculture environment;
determining, based at least in part on the obtained sensor data, an adjustment for the at least one obtained feeding parameters; and
adjusting, based on the adjustment, the at least one obtained feeding parameters.

3. The computer-implemented method of claim 1 where the sensor data describes at least one of water salinity, dissolved oxygen, temperature, water turbidity and weather conditions.

4. The computer-implemented method of claim 1 where the selecting further comprises:
obtaining criteria, where each criterion in the plurality of criteria is associated with at least one obtained feeding parameters; and
based on determining that a criterion among the obtained criteria is satisfied, selecting a feeding parameter associated with the criterion.

5. The computer-implemented method of claim 2 where adjusting further comprises evaluating a machine learning model.

6. The computer-implemented method of claim 5 where the machine learning model is a reinforcement learning model or active learning machine learning model.

7. The computer-implemented method of claim 2 further comprising:
determining, based on evaluating the adjustment against one or more policies in a set of policies, that the adjustment satisfied the one or more policies in the set of policies; and
based on determining that the adjustment satisfied the one or more policies in the set of policies, adjusting, based on the adjustment, at least one of the one or more feeding parameters.

8. A system comprising one or more computers and one or more storage devices storing instructions that when executed by the one or more computers cause the one or more computers to perform operations comprising:
obtaining meal configuration data relating to feeding livestock in an aquaculture environment including: (i) one or more feeding parameters relating to feeding farmed livestock, and (ii) one or more criteria, each of the one or more criteria associated with the one or more feeding parameters;
obtaining sensor data that describes at least one property of the aquaculture environment;
selecting, using the obtained sensor data and the obtained feeding parameters, a selected set of feeding parameters; and
providing the selected set of feeding parameters to a feeding control subsystem.

9. The system of claim 8 the operations further comprising:
obtaining sensor data related to effectiveness of the selected set of feeding parameters from one or more sensors that are configured to measure a property of aquaculture environment;
determining, based at least in part on the obtained sensor data, an adjustment for at least one obtained feeding parameters; and
adjusting, based on the adjustment, the at least one obtained feeding parameters.

10. The system of claim 8 where the sensor data describes at least one of water salinity, dissolved oxygen, temperature, water turbidity and weather conditions.

11. The system of claim 8 where the selecting further comprises:
obtaining criteria, where each criterion in the plurality of criteria is associated with at least one obtained feeding parameters; and
based on determining that a criterion among the obtained criteria is satisfied, selecting a feeding parameter associated with the criterion.

12. The system of claim 9 where adjusting further comprises evaluating a machine learning model.

13. The system of claim 12 where the machine learning model is a reinforcement learning model or active learning machine learning model.

14. The system of claim 9 the operations further comprising:
determining, based on evaluating the adjustment against one or more policies in a set of policies, that the adjustment satisfied the one or more policies in the set of policies; and
based on determining that the adjustment satisfied the one or more policies in the set of policies, adjusting, based on the adjustment, at least one of the one or more feeding parameters.

15. One or more non-transitory computer-readable storage media storing instructions that when executed by one or more computers cause the one or more computers to perform operations comprising:
obtaining meal configuration data relating to feeding livestock in an aquaculture environment including: (i) one or more feeding parameters relating to feeding farmed livestock, and (ii) one or more criteria, each of the one or more criteria associated with the one or more feeding parameters;
obtaining sensor data that describes at least one property of the aquaculture environment;
selecting, using the obtained sensor data and the obtained feeding parameters, a selected set of feeding parameters; and
providing the selected set of feeding parameters to a feeding control subsystem.

16. The one or more non-transitory computer-readable storage media of claim 15 the operations further comprising:
obtaining sensor data related to effectiveness of the selected set of feeding parameters from one or more sensors that are configured to measure a property of aquaculture environment;
determining, based at least in part on the obtained sensor data, an adjustment for at least one obtained feeding parameters; and
adjusting, based on the adjustment, the at least one obtained feeding parameters.

17. The one or more non-transitory computer-readable storage media of claim 15 where the sensor data describes at least one of water salinity, dissolved oxygen, temperature, water turbidity and weather conditions.

18. The one or more non-transitory computer-readable storage media of claim 16 where the selecting further comprises:
obtaining criteria, where each criterion in the plurality of criteria is associated with at least one obtained feeding parameters; and
based on determining that a criterion among the obtained criteria is satisfied, selecting a feeding parameter associated with the criterion.

19. The one or more non-transitory computer-readable storage media of claim 16 where adjusting further comprises evaluating a machine learning model.

20. The one or more non-transitory computer-readable storage media of claim 19 where the machine learning model is a reinforcement learning model or active learning machine learning model.
